(19) United States
(12) Patent Application Publication
(10) Pub. No.: US 2011/0097439 A1
(43) Pub. Date: Apr. 28, 2011

(54) COATED INFUSED FRUIT AND PROCESS OF MANUFACTURING

(76) Inventors: Edward Hirschberg, Hillsborough, CA (US); Zhongli Pan, Davis, CA (US); Tara H. McHugh, Albany, CA (US)

(21) Appl. No.: 12/912,085

(22) Filed: Oct. 26, 2010

Related U.S. Application Data
(60) Provisional application No. 61/254,976, filed on Oct. 26, 2009.

(51) Int. Cl. A23B 7/08; A23B 7/02

(52) U.S. Cl. 426/7; 426/281; 426/242; 426/52

(57) ABSTRACT

Methods for infusing a composition into food products are provided. The resulting infused food products have greatly reduced shrinkage, and resemble fresh food products.

### CROSS-REFERENCES TO RELATED APPLICATIONS

This application claims the benefit under 35 U.S.C. §1.119(e) of U.S. provisional Application No. 61/254,976, filed Oct. 26, 2009, the contents of which are incorporated by reference in the entirety.

### BACKGROUND OF THE INVENTION

Blueberries (Vaccinium) are a rich source of antioxidants such as anthocyanins that protect against such diseases as memory loss, cancer, heart disease, urinary disease, vision problems, and aging (Sweeney et al. Nutritional Neuroscience, 5(6), 427-4231, 2002; Schmidt et al. Journal of Agricultural and Food Chemistry, 52(21), 6433-6442, 2004; Wu et al. Journal of Agricultural and Food Chemistry, 52(12), 4026-4037, 2004; Kalea et al. Journal of Nutritional Biochemistry, 17(2), 109-116, 2005; Norton et al. Journal of Medicinal Food, 8(1), 8-13, 2005). Due to short shelf life of fresh blueberries, after they are harvested in fields, blueberries are usually subjected to freezing immediately and then to sugar infusion and drying subsequently to extend the shelf life of the product. Sugar infusion is widely used for processing of blueberries because it can remove a large amount of water without heating, introduce sugar into fruits, and result in high yield and improved taste of final products (Lenart and Flink Journal of Food Technology, 19, 45-63, 1984; Li and Ramaswamy Drying Technology, 24(5), 619-630, 2006; Nsonzi and Ramaswamy Drying Technology, 16(3-5), 725-741, 1998).

Food product infusion involves a process of replacing water with a high brix solution. Drying of the infused food products results in shrinkage and discoloration of the infused food products. Various infusion methods and parameters have been carried out to study their effects on solid gain, drying characteristics, and other quality characteristics of fresh and infused blueberries (see, e.g., Shi et al., Food Bioprocess Technol, 2:271-278, 2009; Shi et al., Food Engineering and Physical Properties, 73:E259-E264, 2008; Shi et al., Food Science and Technology, 41:1962-1972, 2008).

However, none of these prior art methods are satisfactory in terms of their ability to produce high-quality infused food products having minimal shrinkage and discoloration. A need exists in the art to provide improved methods of food preparation and storage, as well as to provide efficient mechanisms for infusing fruits, vegetables, and other food products. This invention fills these and other needs.

### BRIEF SUMMARY OF THE INVENTION

The invention provides a method of infusing a composition into a food product by incubating the food product with the infusion solution having a Brix of from 50° Brix to 70° Brix at a temperature from 20° C. to 80° C. The food product can be vegetable (e.g., carrot) or fruit (e.g., blueberry, grape, and strawberry).

Prior to the incubating step, the food product is pretreated with a chemical or an enzyme (e.g., sodium hydroxide, potassium carbonate, pectinase or surfactant) to scarify the food product. In some embodiments, the food product is pretreated by boiling in water for a period of time. In some embodiments, the food product is pretreated with a mixture of potassium sorbate, calcium lactate, citric acid, and glycerin, wherein the mixture forms a coating on the food product.

The brix of the infusion solution is typically varied from about 50° Brix to 70° Brix during the incubating step. In some embodiments, the infusion solution has a Brix of from 68° Brix to 70° Brix. In some embodiments, the Brix of the infusion solution is maintained constant during the incubating step. Typically, the infusion process is carried out at a temperature from 50° C. to 80° C.

Typically, the composition used in the method comprises a sugar, e.g., fructose, glucose, dextrose, polydextrose, sucrose, maltodextrin, and corn syrup. The composition often comprise a fruit concentrate comprising high concentration of fructose and glucose. In some embodiments, the sugar is invert sugar. In some embodiments, the infusion solution comprises fruit concentrates pretreated with an invertase. The composition used in the method can comprise other agents, such as glycerol or inulin.

The food product can be partially dehydrated prior to the incubating step, e.g., using infrared heat. The dehydration results in up to about 10% water loss in the food product. The food product can also be coated with a permeable or impermeable coating substance such as vegetable oils, gelatin, pectin, corn zein, shellac and starch to form a coated food product.

In some embodiments, provided herein is a method of infusing invert sugar into blueberries by scarifying the food product by pretreating the blueberries with a solution comprising sodium hydroxide; incubating the blueberries with the infusion solution having a Brix of from 50° Brix to 70° Brix at a temperature from 50° C. to 80° C., thereby infusing the invert sugar into the blueberries; and coating the infused blueberries with a coating material. The blueberries are dehydrated prior to the incubating step. The dehydration can result in up to about 10% water loss in the blueberries. The brix of the infusion solution is maintained constant during the incubating step.

### DETAILED DESCRIPTION OF THE INVENTION

### Definition

As used herein, the following terms have the meanings ascribed to them unless specified otherwise. All other terms have their meanings as commonly understood by one skilled in the art.

The term “food product” refers to materials of either plant or animal origin, or of synthetic sources, that contain an essential body nutrient such as a carbohydrate, protein, fat, vitamin, mineral, etc. Examples include meats, fruits, vegetables, grains, nuts, and the like. As used herein, the term fruit is used in the culinary sense and includes those botanical fruits that are sweet and fleshy. Examples of fruit include, without limitation, apple, strawberry, blueberry, cranberry, plum, peach, mango, banana, pear, grape and orange. The term vegetable is used herein in the culinary sense and includes those plant fruits that are savory, as opposed to sweet. Examples of vegetables include, without limitation, pumpkin, tomato, carrot, onion, bell pepper, beet, cucumber, broccoli and squash. In some embodiments, the food product is blueberry. In some embodiments, the food product is grape.

The term “brix” refers to a unit measurement for measuring the density of the concentration of a chemical such as sugar in a solution. As used in the art, brix refers to a concentration in percent of sugar by weight according to the Brix scale. Brix scale here refers to a hydrometer scale for sugar solutions so graduated that its readings in degrees Brix at a specified temperature represent percentages by weight of sugar in a solution. See Webster's Third New International Dictionary, unabridged, published by G. & C. Merriam Company, Springfield, Mass.

The term “pretreating” refers to a process where a food product is treated chemically or physically before it is infused with a composition.

The term “coating material,” or “coating substance” refers to a composition that can be applied to the food product to be infused to form a protective membrane or coating or layer over the food product. Examples of such coating substance are gelatin, pectin, shellac, zein, and starch.

As used herein, the term “sugar” is meant monosaccharide, disaccharide, and polysaccharide containing materials. Preferably, the sugar comprises fructose, sucrose, glucose, dextrose, polydextrose, maltodextrin, invert sugar and corn syrup or a mixture thereof. In some embodiments, the sugar comprises fruit concentrates pretreated with invertase or fruit concentrates comprising small molecules, e.g., monosaccharides.

As used herein, the term “dehydration” refers to any process by which the amount of water is reduced in a food item

### I. Introduction

The present invention provides for a method of infusing a composition into a food product using a high-brix infusion solution. A unique process has been discovered that produces infused food products with superior qualities, e.g., better shape and texture. By using a combination of particular infusion conditions, infusion components, pre-infusion treatments and post-infusion treatments, the infused food product has greatly reduced shrinkage, e.g., minimal shrinkage or no shrinkage. This allows production of infused food products that resemble fresh food products.

### II. Infusion Conditions

The infusion process is conducted by incubating a food product with an infusion solution having a brix of from about 20° Brix to about 80° Brix at a temperature from 20° C. to 80° C. Typically, the brix of the infusion solution is from about 30° Brix to about 70° Brix. Preferably, the brix of the infusion solution is from about 50° Brix to about 70° Brix. In some embodiments, the brix of the infusion solution is from 40-60° Brix, or from 60-80° Brix. In some embodiments, the brix of the infusion solution is from 68-70° Brix. In some embodiments, infusion is conducted at about 70° Brix.

The brix of the infusion solution can be maintain in a static system, i.e., components of the infusion solution are not continuously added into the system. In some embodiments, the infused products are transferred to a new batch of infusion solution, e.g., every hour, every 6 hours, every 12 hours or every day. In some embodiments, every batch of infusion solution has a same brix value. In some embodiments, the brix of the infusion solution can be optionally varied, e.g., from batch to batch.

The brix of the infusion solution can also be maintain in a dynamic system, i.e., the brix of the infusion solution is continuously adjusted. Because the solutes (e.g., sugars) are absorbed into the infused food products, the brix of the infusion solution decreases during the incubating step if left undisturbed, e.g., in a static system and without adding solute to the solution. Therefore, to maintain the brix of the infusion solution constant or otherwise within a certain range during the incubating step, it is expected that a person of skill is able to adjust the brix of the solution by various methods known in the art, e.g., by adding solute to the solution, and/or by partial or complete replacement of the solution. In some embodiments, the brix of the infusion solution is maintained at a value between about 20° Brix to about 80° Brix, between about 30° Brix to about 70° Brix, about 50° Brix to about 70° Brix, 40-60° Brix, 60-80° Brix, 68-70° Brix, or about 70° Brix during the incubating step. In some embodiments, the brix of the infusion solution is maintained constant during the incubating step. In some embodiments, the brix of the infusion solution is increased over a period of time. For example, the brix of the infusion solution can be increased from 20° B to 65° B.

Typically, the infusion process is carried out at a temperature from 30° C. to 80° C. In some embodiments, the infusion process is carried out at a temperature from 40° C. to 80° C., from 50° C. to 80° C., from 60° C. to 80° C., from 70° C. to 80° C., from 40° C. to 50° C., from 50° C. to 60° C., or from 60° C. to 70° C. In some embodiments, the infusion process is carried out at 120 Fahrenheit. In some embodiments, the infusion process is carried out at room temperature. The temperature can be maintain constant during, the incubating step. Optionally, the infusion can be speeded up by increasing the temperature.

In some embodiments, a combination of particular brix values and particular temperatures are used for the infusion process. For example, when the brix of the infusion solution is lower than 50° B, the infusion process is carried out at about 30° C. When the brix of the infusion solution is higher than 60° B, the infusion process is carried out at about 50° C. In some embodiments, the infusion process is carried out at about 50° C. in an infusion solution having a brix of about 70° B.

Optionally, the infusion solution and the food product can be mixed during the infusion process. Various methods of mixing infusion solution can be used. For example, as detailed in the examples, the infusion solution can be mixed by bubbling air through the solution, or by transferring the infusion solution between different containers.

### III. Infusion Components

The infusion process is selected to provide a final product that has a smooth surface, and that retains most of its original size and appearance. The solution may include a salt component, a sugar component or a combination. The salt may be, for example, sodium chloride. The sugar can comprise any of a number of saccharide materials including monosaccharides, disaccharides and polysaccharides and their degradation products, e.g., pentoses including aldopentoses, ketopentoses like xylose and arabinose, a deoxyaldose like rhamnose, hexoses and reducing saccharides such as aldohexoses like glucose, galactose and mannose; the ketohexuloses, like sorbose and xylulose; disaccharides, like maltulose, lactose and maltose; nonreducing disaccharides such as a sucrose, other polysaccharides such as dextrin and raffinose, and hydrolyzed starches which contain as their constituents oligosaccharides. The sugar can also comprise a low molecular weight sugar. Examples of sugars useful for the present invention further include, but are not limited to, fructose, dextrose, polydextrose, sucrose, maltodextrin, corn syrup, deionized fruit concentrate, high fructose corn syrup, and white grape juice concentrate. In some embodiments, the sugar is invert sugar. The invert sugar can be produced by fruit concentrates pretreated with an invertase.

The infusion solution can further include an additional infusion agent. Examples of additional infusion agents include glycerol, inulin, and other polyhydric alcohols and the like. When polyhydric alcohols (e.g., glycerol) are employed, they preferably comprise only about 1 to about 10% of the sugar component. Various flavorings, color additives, phytochemicals and nutraceuticals can be included in the infusion solution. Examples of various phytochemicals and nutraceuticals suitable for infusing a food product are described in U.S. Pat. No. 6,440,449, which is incorporated by reference herein in its entirety.

The infusion can be performed in various containers readily available in the art. For example, the containers for the infusion are typically made of plastic or other polymer materials. Other materials that can be used for the container include stainless steel, aluminum, glass, or other ceramics. When applicable, the heat source can be applied to the container internally or externally, or both, by a heating means such as a heating rod, open burner, closed burner, electrical heating element, or the like.

### IV. Pretreatments

According to the present invention, the food products (either fresh or frozen) are subject to various pretreatment prior to the infusion process. For example, the food products can be pretreated with a chemical or an enzyme in order to scarify or etch the skin or surface of the food product. For example, many fruits (e.g., blueberry) have waxy cuticles on the surface, which can impede or even inhibit the infusion process. It was discovered in the present invention that removal of this waxy cuticle greatly enhances the infusion process.

In some embodiments, the food products are pretreated with a base, e.g., sodium hydroxide, potassium carbonate or other food grade surfactant. Examples of other suitable bases include, but is not limited to, compounds containing alkali metals or alkali earth metals, although it is appreciated by the skilled artisan that bases containing other types of metals may be used. Examples of inorganic bases include, but are not limited to, sodium carbonate, sodium bicarbonate, potassium hydroxide, calcium hydroxide, magnesium hydroxide, and the like. Organic bases in the form of, for example, nitrogen-containing components may be also used. Exemplary nitrogen-containing compounds include, but are not limited to, ammonium, organic amines, and the like. It is expected that a person of skill is able to adjust the concentration of the base, the temperature of the pretreatment, and the duration of the pretreatment in order to achieve best results. In some embodiments, a 0.1% sodium hydroxide solution is used to pretreat the food products.

Other method can be used to scarify the food products provided herein. In some embodiments, the food products are boiled in water for a period of time. In some embodiments, the food products are treated with glycerol (e.g., 2% glycerol). In some embodiments, the food products are treated with a vegetable oil (e.g., 2% olive oil). In some embodiments, the food products are treated with pectinase. In some embodiments, the food products are pretreated with a mixture comprising potassium sorbate, calcium lactate, citric acid, and glycerin, wherein the mixture forms a coating on the food product.

The food products can also be dehydrated prior to the incubating step. For example, the food products can be dehydrated prior to the incubating step to lose 1%, 2%, 5%, 7%, or 10% water. Various dehydration methods known in the art can be use. It is discovered that dehydration by infrared heat is particularly advantageous.

### V. Coating

According to the present invention, the infused food products can be further coated with a coating material once the infusion process is finished. It is discovered in the present invention that the coating of the infused products helps to maintain the shape and texture of the infused food products. Various coating materials can be used, e.g., vegetable oils, gelatin, pectin, corn zein, shellac and starch. In some embodiments, impermeable (impervious) coating materials can be used, for example, shellac and zein. Permeable and impermeable coatings can be used together.

### EXAMPLES

The following examples are offered to illustrate, but not to limit the claimed invention.

### Example 1

### Impervious Coated Infused Fruit and Process of Manufacturing

Taking fresh or frozen thawed blueberries, pin prick, scarify, etch by use of 0.5% sodium hydroxide, potassium carbonate, boiled water or treat skin with 2% olive oil or pectinase DV.2.

Place in a bath containing potassium sorbate (0.24% w/v), calcium lactate (0.48% w/v), citric acid (0.96% w/v), glycerin (0.192% w/v), and natural flavoring (0.2% w/v). The ratio of blueberry to infusion solution was 1:1 in weight.

The following day, and each successive day, remove 20% by weight of solution and fruit and replace with 68 degrees brix, extra light white grape juice concentrate (other materials may be substituted such as inulin, sugar, high fructose corn syrup, glycerin invert sugar, deionized fruit concentrate, concentrate treated with invertase, etc.). Preferably use solutions with small molecules.

Infrared initial drying in combination with sodium hydroxide skin treatment to the extent of 10%-20% moisture removal, significantly increases the speed of infusion.

The following alternative considerations in processing may be performed in speeding up the process and retaining uniform transfer of moisture out and infusing media in:
Retain a constant 70° brix solution.
Heat retained at 120° F.
Vibrate the solution: bubble air up through the tank and/or use suction to transfer from one tank to the next by siphoning higher brix media to a lower brix tank.

These means will place new media in contact with the fruit. In some cases dehydrating of infrared drying or 10% reduction of moisture speeded the infusion with no ill effects to the product. Glycerin may be infused in the last soaking to reduce the water activity.

When the moisture level is below 35%, or 0.6% AW, and simultaneously causing transfer, retaining a smooth exterior of the food, an impervious coating of zein or similar material is applied.

The product is removed from the bath, rinsed, surface air dried or dusted with starch or similar material. The zein is sprayed on the product using a panning step followed by blowing dry air to reduce sticking together. Another procedure is electrostatic coating.

Another method of producing infused products is taking particulates and infusing prior to or subsequently after forming into balls using a penetrable coating of polymeric material and infusing through coating; thereafter coating with zein.

### Example 2

### Processing and Infusion Methods for Blueberries

The objectives of the experiments are to (1) investigate the processing characteristics of blueberries in sugar infusion at solution/fruit ratio of 1:1 and optimizing the processing conditions in terms of temperature, solute concentration, infusion media and infusion mode; (2) investigate the drying and quality characteristics of infused blueberries under different IR heating conditions; (3) investigate the application of IR in drying fresh blueberries to shelf stable water activity and partially drying fresh blueberries before infusion. Mainly results were reported as followings:

### 1. Characteristics of Sugar Infusion of Blueberries

Individual quick frozen (IQF) blueberries of the Patriot variety, provided by the Gladwin Farms Ltd (Abbotsford BC, Canada), were used in the infusion studies. Three infusion setups were used in the study: a regular water bath used in static infusion; a Reciprocal water bath shaker used in dynamic infusion to make the solution moving continuously around the fruits; a newly developed recycling infusion setup in dynamic infusion to make the solution cycling around the fruits and provide stable concentration of infusion agents during the infusion processing.

During the infusion, samples were tested on the weight, moisture content, and water activity by intervals. Solid gain per initial dry solid (SG), water loss (WL), yield of shelf-stable products with moisture content of 14% w.b.(Y), moisture ratio (MR) and change of color after drying was calculated by the following equations:

SG=((Wₜ*(1−Mₜ)−W₀*(1−M₀))/(W₀*(1−M₀)) (1)

WL=(Wₜ*Mₜ−W₀*M₀)/(W₀*(1−M₀)) (2)

Y=(Wₜ*(1−Mₜ))/W₀/0.86 (3)

Where, W and M are the weight and moisture content (w.b.) of samples, respectively; subscript of t and 0 indicate the values at time t and 0, respectively; 0.86 is the solid content (w.b.) of end products with moisture content (w.b.) of 14%.

### 1.1 Batch Infusion: Effect of Temperature and Concentration of Infusion Media

Trials were conducted in the dynamic system by using the water bath shaker. Sucrose solution was used as the infusion media. The ratio of solution to blueberries was 1:1. Infusion conditions were listed in Table.1

TABLE 1
Temperatures and concentration of
sucrose solution used for infusion

| 25° C. | 30° C. | 40° C. | 50° C. | 60° C. | 70° C. |
|---|---|---|---|---|---|
| 20 Brix | 20 Brix | 20 Brix | 20 Brix | 20 Brix | 20 Brix |
| 30 Brix | 30 Brix | 30 Brix | 30 Brix | 30 Brix | 30 Brix |
| 40 Brix | 40 Brix | 40 Brix | 40 Brix | 40 Brix | 40 Brix |
| 50 Brix | 50 Brix | 50 Brix | 50 Brix | 50 Brix | 50 Brix |
| 60 Brix | 60 Brix | 60 Brix | 60 Brix | 60 Brix | 60 Brix |
| 70 Brix | 70 Brix | 70 Brix | 70 Brix | 70 Brix | 70 Brix |

During the infusion, the moisture content and water activity of blueberries decreased, while Brix of blueberries increased continuously due to the water loss and solid gain in blueberries. In sugar solution of fruits, the solid gain is mainly caused by the accumulated solute in blueberries. In the study, dry solid gain per initial dry solid showed nearly linear increase with the Brix of blueberries. Therefore, Brix of blueberries was taken as a main parameter to indicate the increase of solid in blueberries in the following studies.

During the infusion course, the Brix of blueberries and the Brix of solution showed logarithmic increase and decrease, respectively, under all infusion conditions. Temperature and concentration of infusion solution showed significant effect on the rate of Brix increase in the blueberries and Brix decrease in solution. Sucrose concentration in blueberries increased with infusion time, infusion temperature and concentration of infusion solution. The difference of sugar concentration in blueberries between sucrose solutions was enlarged at higher temperature. It was also indicated that the sucrose content in blueberries increased greatly at the first 1-2 hours in the infusion and slowly at late stage. This is because water loss is more intensive in first stage than later stage. This contributed to the fast increase of soluble solid content in blueberries besides of sugar gain. In order to investigate the efficiency of sugar going into blueberries, solid gain was calculated according to the following function: The results showed solid gain also increased with increasing temperature and concentration of in fusion solution. Higher concentration of solution gave higher solid gain at certain time, for example, 1.143-1.178 g/g in 70 Brix solution and 0.188 g/g in 20 Brix solutions. Higher temperature resulted in faster infusion. For example, the point of inflexion of time at late logistic increase of solid gain was 180 min at 60° C. but 240 min at 25° C. for infusion in sucrose solutions of 30-50 Brix.

Time needed for the system to reach equilibrium decreased greatly at high temperature. At 60° C., the infusion system reached to equilibrium within 300 min for all levels of initial solution concentration. At 25° C., it took much longer than 500 min to get the equilibrium. The Brix of blueberries at equilibrium point increased with the increase of infusion solution concentration. The acceleration of Brix of blueberries caused by the increase of temperature increased with the concentration of infusion solution.

With the increase of temperature and concentration of infusion solution, the rate of Brix gain in blueberries and Brix loss in solution increased continuously. The increase of Brix in blueberries caused by high solution concentration was accelerated when high temperature was used. For example, the Brix of blueberries was greatly increased at 60° C., but was lightly affected at 25° C. when the Brix of solution increased from 60 Brix to 70 Brix.

In order to investigate the real increase of solids in blueberries, we analyzed the solids gain and water loss on the basis of the unit initial dry solid, which is the unique unchanged parameter during the course. Results showed increasing temperature is more preferable for solid gain than for water loss. Increase of infusion solution concentration enhanced the water loss and Brix of blueberries at all temperatures. The acceleration of water loss and Brix of blueberries caused by the increase of infusion solution concentration, however, was more significant at 60° C. than that at 25° C. When temperature increased from 25° C. to 60° C., the solid gain increased while water loss decreased. At 25° C., the water loss was much higher than solid gain, especially at the first infusion stage. The difference between water loss and solids gain decreased when temperature increased because of the increased sugar diffusivity at high temperature.

In order to find out the optimal condition for getting high yield of infused blueberries in short time, we compared the properties of blueberries infused for 120 min and 300 min. The results were shown in Table 2.

After infusion for 120 min, Brix of blueberries showed a peak at 70° C. and infusion solution concentration of 70 Brix. After infusion for 300 min, another peak showed for the Brix of blueberries at 50° C. and infusion solution concentration of 70 Brix. The moisture content of wet blueberries and yield of shelf-stable products (with moisture content (w.b.) of 14%) showed the reverse and same trends, respectively. When infusion time prolonged from 120 to 300 min, the Brix of blueberries increased greatly at 50° C. and solution concentration of 70 Brix, but slightly under other conditions. Brix of blueberries showed an almost linear relationship with the yield of shelf-stable products. It took only 120 min for the Brix of blueberries to reach the highest value by using 70 Brix sucrose solution at 70° C. and took 300 min by using 70 Brix solution at 50° C. to reach the similar high value. However, the product quality of blueberries was badly decreased when infusion temperature was higher than 60° C. It showed as the skin of blueberries was removed and the color of blueberries was brown. Such negative influence was not found at 50° C.

To sum up, the optimal condition for processing infused blueberries should be 50° C. and infusion solution concentration of 70 Brix. When the energy consumption was considered, high concentration of solution was recommended to get high infusion rate and high yield of products.

For the quality of products, a significant change of color showed when temperature was lower than 30° C. At temperatures higher than 30° C., the browning of blueberries increased with the increased temperature. Infused blueberries looked more brown and redder at higher temperatures from 40° C. to 70° C. The skin of blueberries was destructed slightly at 60° C. and completely removed at 70° C. when infusion time is longer than 2 hours in the dynamic infusion system. There was also a kind of cooked smell and taste in blueberries infused at 50° C., 60° C. and 70° C. The cooked smell and taste is stronger at higher temperature than lower temperature.

TABLE 2
Properties of blueberries after infusion for 120 min and 300 min

| | Infusion for 300 min | | | | | | Infusion for 120 min | | | | | |
|---|---|---|---|---|---|---|---|---|---|---|---|---|
| | 25° C. | 30° C. | 40° C. | 50° C. | 60° C. | 70° C. | 25° C. | 30° C. | 40° C. | 50° C. | 60° C. | 70° C. |
| | Brix of blueberries | | | | | | | | | | | |
| 20 Brix | 14.4 | 15.7 | 15.7 | 18.9 | 16.8 | 18.1 | 14.4 | 16.3 | 14.5 | 14.9 | 15.5 | 16.4 |
| 30 Brix | 18.9 | 20.8 | 21.7 | 24.9 | 21.9 | 24.0 | 17.2 | 20.1 | 19.3 | 21.5 | 20.4 | 22.1 |
| 40 Brix | 24.1 | 25.3 | 27.8 | 30.3 | 27.5 | 30.2 | 20.5 | 25.4 | 24.2 | 25.6 | 25.1 | 28.2 |
| 50 Brix | 25.8 | 31.9 | 33.3 | 37.2 | 34.5 | 37.1 | 22.7 | 29.4 | 28.6 | 26.4 | 29.2 | 30.4 |
| 60 Brix | 31.6 | 32.5 | 40.0 | 45.3 | 39.6 | 43.4 | 24.6 | 28.9 | 34 | 27.5 | 35.4 | 34.4 |
| 70 Brix | 31.1 | 37.2 | 44.3 | 49.7 | 43.7 | 48.0 | 21.2 | 28.5 | 33 | 28.8 | 36.9 | 45.7 |
| | Water content (w.b.) (g/g) | | | | | | | | | | | |
| 20 Brix | 0.81 | 0.79 | 0.79 | 0.75 | 0.78 | 0.77 | 0.80 | 0.82 | 0.79 | 0.78 | 0.80 | 0.80 |
| 30 Brix | 0.76 | 0.76 | 0.73 | 0.70 | 0.74 | 0.72 | 0.78 | 0.77 | 0.76 | 0.75 | 0.77 | 0.74 |
| 40 Brix | 0.73 | 0.73 | 0.69 | 0.64 | 0.69 | 0.67 | 0.75 | 0.75 | 0.71 | 0.71 | 0.73 | 0.68 |
| 50 Brix | 0.68 | 0.65 | 0.63 | 0.60 | 0.62 | 0.60 | 0.72 | 0.69 | 0.67 | 0.71 | 0.67 | 0.65 |
| 60 Brix | 0.67 | 0.64 | 0.57 | 0.53 | 0.58 | 0.54 | 0.72 | 0.68 | 0.65 | 0.69 | 0.63 | 0.62 |
| 70 Brix | 0.66 | 0.63 | 0.54 | 0.49 | 0.53 | 0.49 | 0.72 | 0.67 | 0.63 | 0.69 | 0.60 | 0.52 |
| | Brix of solution | | | | | | | | | | | |
| 20 Brix | 18.9 | 15.7 | 15.7 | 18.9 | 16.8 | 18.1 | 18.6 | 16.3 | 14.5 | 14.9 | 15.5 | 16.4 |
| 30 Brix | 27.0 | 20.8 | 21.7 | 24.9 | 21.9 | 24.0 | 25.5 | 20.1 | 19.3 | 21.5 | 20.4 | 22.1 |
| 40 Brix | 32.9 | 25.3 | 27.8 | 30.3 | 27.5 | 30.2 | 30.5 | 25.4 | 24.2 | 25.6 | 25.1 | 28.2 |
| 50 Brix | 43.7 | 31.9 | 33.3 | 37.2 | 34.5 | 37.1 | 41.2 | 29.4 | 28.6 | 26.4 | 29.2 | 30.4 |
| 60 Brix | 56.2 | 32.5 | 40.0 | 45.3 | 39.6 | 43.4 | 50.9 | 28.9 | 34.0 | 27.5 | 35.4 | 34.4 |
| 70 Brix | 64.7 | 37.2 | 44.3 | 49.7 | 43.7 | 48.0 | 58.2 | 28.5 | 33.0 | 28.8 | 36.9 | 45.7 |
| | Yield of shelf stable products (MC = 14% w.b.) | | | | | | | | | | | |
| 20 Brix | 0.19 | 0.21 | 0.22 | 0.23 | 0.25 | 0.16 | 0.19 | 0.20 | 0.19 | 0.21 | 0.21 | 0.23 |
| 30 Brix | 0.25 | 0.25 | 0.30 | 0.30 | 0.29 | 0.25 | 0.21 | 0.23 | 0.23 | 0.26 | 0.30 | 0.31 |
| 40 Brix | 0.26 | 0.27 | 0.49 | 0.36 | 0.36 | 0.32 | 0.20 | 0.24 | 0.26 | 0.31 | 0.28 | 0.40 |
| 50 Brix | 0.34 | 0.35 | 0.43 | 0.42 | 0.44 | 0.41 | 0.22 | 0.25 | 0.31 | 0.32 | 0.36 | 0.43 |
| 60 Brix | 0.33 | 0.35 | 0.37 | 0.52 | 0.48 | 0.49 | 0.23 | 0.27 | 0.31 | 0.31 | 0.39 | 0.47 |
| 70 Brix | 0.36 | 0.35 | 0.54 | 0.58 | 0.53 | 0.54 | 0.24 | 0.23 | 0.34 | 0.32 | 0.41 | 0.61 |

Very slightly increase of solid gain showed when Brix of solution was higher than 50 Brix at 30° C. Reversely, great increase of solid gain showed at 50° C. when concentration of infusion solution was higher than 60 Brix. In batch infusion, therefore, it was recommended to use temperature lower than 40° C. when Brix of infusion solution was lower than 50 Brix and to use temperature higher than 50° C. when higher than 60 Brix. In this way, the solid gain of blueberries might be maximized in short time. High concentration of infusion solution was recommended to get higher solid gain at shorter time and high yield of end products at all conditions.

### 1.2 Batch Infusion: Effect of Berry Skin

There is a waxy layer and skin outside blueberry, which is assumed to have inhibition effect on the mass transfer between the fruits and infusion solution. In order to investigate the role of berry skin in the infusion processing, infusion was conducted in the static infusion system by using the normal water bath at given temperatures. Frozen blueberries were infused directly or after peeling by hand. Different pretreatment methods, including dipping blueberries into different solutions for specific times (Table.3) were tried to reduce the inhibition of skin and waxy layer to the influx of Brix into blueberries. 60° Brix sucrose solution was used as infusion media in the trials at solution to blueberries ratio of 1:1.

TABLE 3
Pretreatments used to increase the infusion
rate of Brix in blueberries

| Pretreatment | Concentration of | | | Pretreatment |
|---|---|---|---|---|
| agent | the agent | Pretreatment time | | temperature |
| NaOH | 0.1% | 5 | sec | 93° C. |
| NaOH | 0.3% | 5 | sec | 93° C. |
| NaOH | 0.5% | 5 | sec | 93° C. |
| Glycerol | 2.0% | 3 | min | 25° C. |
| Glycerol | 2.0% | 3 | min | 80° C. |
| Glycerol | 2.0% | 3 | min | 100° C. |
| Water | — | 1 | min | 100° C. |

Peeled blueberries showed much higher sugar infusion rate than did unpeeled blueberries, which was independent of berry size, infusion temperature and concentration of infusion solution. Less time was needed for the system to get equilibrium and rate of Brix increase in blueberries was increased after the peeling treatment. At same time, the Brix of blueberries increased by nearly 2 times after the skin was removed. For infusion with 60 Brix sucrose solution, increasing temperature to 80° C. could greatly enhance the rate of Brix increase for unpeeled blueberries but slightly influence on that for peeled blueberries. At 50° C., the influence of infusion solution concentration on the increase rate of Brix in blueberries was greater for peeled blueberries than for unpeeled blueberries. For increasing the rate of Brix increase in blueberries, increasing temperature is more efficient than is increasing the concentration of infusion solution for unpeeled blueberries. The trend is opposite for peeled blueberries in this case.

Pre-treating blueberries in boiling water for 1 min, or dipping blueberries in 2.0% glycerol solution at 80° C. and 100° C. for 3 min and dipping blueberries in 0.1% NaOH for 5 sec could greatly facilitate the infusion of solid to blueberries during infusion treatment. NaOH. In view of the negative effect of long high temperature treatment on the color and quality of products, dipping in 0.1% NaOH showed more acceptable for pretreatment of blueberries.

### 1.3 Batch Infusion: Effect of Infusion Media

Seven different infusion media, including dextrose, fructose, polydextrose, corn syrup, apple concentrate, maltodextrose and sucrose, were tested to study the effect of infusion media on the mass transfer characteristics of blueberries in the infusion processing. The concentration of the infusion solution was 60° Brix for all infusion media. All infusion tests were conducted at 30° C. The ratio of infusion solution to blueberries was 1:1.

As expected, the water activity of blueberries decreased more greatly in solutions of smaller molecules, such as monosaccharide of dextrose, fructose and apple concentrate. Disaccharide, such as sucrose took the second order. Bigger molecular, such as poly dextrose, corn syrup and maltodextrose reduced the water activity of blueberries very slightly during the course of infusion. Except the curve of sucrose was distorted in the trend, the water content of blueberries decreased when bigger sugar molecular was used. Apple juice showed similar behavior between the fructose and sucrose.

### 1.4 Keeping Solution Concentration at Relatively Stable Levels Throughout the Processing

In view that the decrease of solution concentration would reduce the infusion rate of solute into blueberries, work was made to keep the concentration of solution at relative stable throughout the whole infusion course. In static system, blueberries were transferred to another new solution with same concentration as its original value. In dynamic system, concentration of infusion solution was kept at 60 Brix by continuously adding concentrate sugar solutions in the solution tank.

Keeping the concentration of infusion solution at a relative stable level could greatly enhance the increase rate and value of Brix of blueberries. The increase degree increased with the concentration of infusion solution. At 60° C., the Brix of blueberries increased to above 60 Brix within 250 min when the concentration of infusion solution was kept relative stable at 77 Brix. If no sucrose was added during the infusion course, the Brix of blueberries could only reach to 35 Brix even when the time was prolonged to 700 min. It indicated that high concentration of infusion solution was essential to get high Brix of blueberries at all conditions.

When the following infusion strategies (Table.4) were applied, the effect of constant Brix in solution on the infusion rate of Brix in blueberries could be compared. In general, the Brix of blueberries increased greatly when dynamic infusion system was used or solution concentration of blueberries was kept stable at 60 Brix. In the dynamic infusion system, the increase of blueberry Brix at 25° C. was even higher than that in static infusion system at 60° C. when the solution concentration was not controlled. Keeping solution concentration at a relative stable high level, the Brix of blueberries could also be increased greatly, which was accelerated when high temperature was used. The Brix of blueberries increased greatly, even higher than that in the dynamic system at 25 Brix, when concentration of solution was kept relative stable at 60 Brix and temperature was increased to 80° C.

TABLE 4
Infusion strategies used for infusion of blueberries

| | | Ratio of solution | | Concentration | |
|---|---|---|---|---|---|
| | | to blueberries | Infusion setup | of solution | Temperature |
| Dynamic | DI-25C | 1:1 | Water bath | 60° Brix | 25° C. |
| system | | | shaker | | |
| | DC-25C | 5:1 | Recycling | Constant at | 25° C. |
| | | | infusion setup | 60° Brix | |
| Static | SI-25C | 1:1 | Water bath | 60° Brix | 25° C. |
| system | SI-60C | 1:1 | Water bath | 60° Brix | 60° C. |
| | SC-60C | Changing solution | Water bath | 60° Brix | 60° C. |
| | | (1:1) every hour | | | |

### 2. Drying Characteristics of Sugar-Infused Blueberries Under IR Heating

### 2.1 Effect of Temperature

Four temperatures were tested at 60, 70, 80, and 90° C. for sucrose infused blueberries having moisture content of 49%. The drying rate was greatly increased when temperature increased from 60 to 80° C., but very slightly when temperature increased from 80° C. to 90° C. The effect of drying temperature on texture and color quality did not show any significant trend for sugar-infused blueberries even though that some data were statistically different. The variation of texture and color of dried with different temperatures in relatively narrow ranges. Highest springiness and cohesiveness and lowest total change of color was obtained for sugar-infused blueberries. Therefore, 80° C. was recommended for the IR drying of sugar infused blueberries. Using 60 min for IR drying, 300 min for sugar infusion at 500 with 70 Brix sugar solution, or 180 min for infusion at 60° C. with solution concentration relative stable at 77 Brix, the total time for producing shelf-stable sugar infused blueberries would be 240-350 min with product yield of 53 g/100 g.

### 2.2 Effect of Solid Content

Blueberries were infused in 60 Brix solutions of sucrose and fructose syrup to get the moisture content (w.b.) of 74%, 63%, 56% and 49% by using the recycling infusion system. The corresponding Brix of the infused blueberries was listed in Table 4. The infused blueberries were dried at 70° C. by using IR heating.

At the first drying stage, samples of higher moisture content and lower solid content showed higher drying rate, and reversely in the later drying stage. Samples infused with sucrose and fructose syrup showed almost the same trend in this case. It indicated, samples with low solid content would be easy to be dried to a certain low level of moisture content. In this way, the total processing time would be prolonged when high solid containing products were required.

### Table 5 Brix and Moisture Content of Infused Blueberries Prepared for Drying

TABLE 5
Brix and moisture content of infused
blueberries prepared for drying

| | Brix of blueberries infused | |
|---|---|---|
| Moisture | with different media | |
| content (% w.b.) | sucrose | fructose syrup |
| 74 | 18 | 25 |
| 63 | 31 | 35 |
| 56 | 44 | 40 |
| 49 | 50 | 50 |

### 2.3 Effect of Infusion Media

Blueberries were infused in 60° Brix solutions of sucrose and fructose to get Brix of 48 by using the recycling infusion system. The infused blueberries were dried at 70 and 80° C. under IR heating. For blueberries with same solid content, samples infused with sucrose showed much higher drying rate than did that infused with fructose for all drying temperatures. Water activity of samples infused with fructose, however, decreased faster than did that infused with sucrose. It indicated infusion with fructose, compared to sucrose, might output more shelf-stable products with higher water content at same water activity. In other words, infusion with fructose would be helpful to increase the yield of end products.

### 3. IR Drying of Fresh Blueberries

Effect of temperature, size of blueberry, and waxy cuticle removing treatment was studied IR drying rate. Keeping stable and variational temperature was also tried for drying bulk of blueberries. After which, proper drying method was recommended. Blueberries partially dried with IR were frozen or not frozen before being infused in syrup to investigate the effect of IR treatment on infusion rate. Weight loss of blueberries was measured during the drying period and expressed as percentage of the initial weight. Fresh blueberries used in all experiments were bought from Safeway in Davis city. The power of IR was always set at 4000 W for all experiments. Heating system was controlled according to the surface temperature of blueberries.

### 3.1 Effect of Temperature on the Drying Characteristics and Product Quality

With increasing drying temperature in the tested range, the amount of moisture removed from blueberries increased and the time to achieve specific moisture content in finished products was reduced. However, when the drying temperature was increased from 80 to 90° C., the increase of drying rate was less than that from 60° C. to 70° C. IR drying had much higher drying rate compared to the hot air drying. The required IR drying times for obtaining the final products(aw=0.6) were 540, 210, 120, and 90 min at 60, 70, 80, and 90° C. drying temperature, respectively, which were corresponded to 44%, 78%, 88%, and 91% savings in drying time compared to the hot air drying at 60° C. (960 min).

In general, the IR dried blueberries were much firmer in texture, darker, redder and less blue in color than the undried blueberries and dried blueberries with hot air. It is also observed a greater color change of IR dried product than that of hot air dried berries. Compared to the IR dried non-infused products, the IR dried infused products were much firmer, more cohesive, chewier and less springy in texture due to their higher solid contents. Although they had lower L and a values and higher b compared to fresh blueberries, the color of dried products were very similar by visual observation. The effect of drying temperature on texture and color quality did not show any significant trend for fresh blueberries even though that some data were statistically different. The variation of texture and color of dried with different temperatures in relatively narrow ranges. Highest springiness and cohesiveness and lowest total change of color was obtained at 70° C. for dried blueberries. It was also observed that many fresh blueberries were broken during the IR drying resulting in a strong burning smell when the drying temperature was above 80° C. (Table.6). Compared to the quality of blueberries dried with convective hot air at 60° C., 70° C. is recommended for IR drying of both fresh and infused blueberries to achieve a good balance of time saving and high quality product.

TABLE 6
Texture and color quality of dried blueberries

| Drying | | | | | | | | | |
|---|---|---|---|---|---|---|---|---|---|
| conditions | | Hardness | Springiness | Cohesiveness | Chewiness | L | a | b | ΔE |
| Fresh | Undried | 1.1^{c} | | | | 39.0^{a} | 0.2^{e} | −1.8^{g} | / |
| blueberries | Hot air | 1.4^{c} | 0.73^{ab} | 0.18^{b} | 0.2^{ef} | 41.0^{a} | 4.0^{b} | −1.1^{f} | 4.3 |
| | IR-60° C. | 30.3^{c} | 0.69^{ab} | 0.28^{b} | 5.9^{e} | 22.1^{b} | 10.5^{a} | 1.2^{a} | 20.0 |
| | IR-70° C. | 25.7^{ab} | 0.80^{a} | 0.54^{b} | 11.1^{d} | 20.2^{bc} | 3.6^{b} | −0.2^{b} | 19.1 |
| | IR-80° C. | 34.4^{c} | 0.61^{ab} | 0.15^{b} | 3.2^{e} | 19.7^{bc} | 1.7^{d} | −0.6^{de} | 19.4 |
| | IR-90° C. | 32.6^{cd} | 0.64^{ab} | 0.19^{b} | 4.0^{e} | 16.1^{de} | 2.5^{c} | 0.2^{bc} | 23.1 |
| Sugar- | IR-60° C. | 46.5^{b} | 0.56^{b} | 4.71^{a} | 122.7^{c} | 13.6^{e} | 1.2^{d} | −0.6^{e} | 25.4 |
| infused | IR-70° C. | 49.8^{ab} | 0.69^{ab} | 4.81^{a} | 165.2^{b} | 19.8^{bc} | 1.7^{d} | −0.5^{de} | 19.2 |
| blueberries | IR-80° C. | 56.7^{a} | 0.58^{ab} | 5.55^{a} | 182.4^{a} | 17.3^{cd} | 1.0^{d} | −0.4^{cd} | 21.8 |
| | IR-90° C. | 45.5^{b} | 0.63^{ab} | 4.65^{a} | 133.3^{c} | 15.8 e | 1.1^{d} | −0.4^{bcd} | 23.2 |
| IRavg ± sd | Fresh | 30.8 ± 3.8 | 0.69 ± 0.08 | 0.29 ± 0.18 | 6.0 ± 3.6 | 19.5 ± 2.5 | 4.6 ± 4.1 | 0.1 ± 1.0 | 20.4 ± 1.8 |
| | Infused | 49.6 ± 5.0 | 0.62 ± 0.06 | 4.93 ± 0.42 | 151.2 ± 30.2 | 16.6 ± 2.6 | 1.3 ± 0.3 | 0.5 ± 0.1 | 22.4 ± 2.6 |

Note:
Mean values followed by different letters in a same column are significantly different at p < 0.05 level;
IRavg is the mean value of results for samples dried with IR at temperatures from 60° C. to 90° C.;
sd is the standard deviation.

### 3.2 Effect of Berry Size on the Drying Rate

When heating temperature was controlled according to the surface of blueberries in diameter of 16 mm, the berry size did not show great influence on the drying rate although the bigger blueberries showed lower drying rate than did smaller ones. Bulk of blueberries showed same drying behavior as did blueberries in diameter from 13 to 16 mm. It should be mentioned that the drying rate would be distorted significantly from that of bulk blueberries when the size of blueberries was too small (11 mm in diameter).

Therefore, it was suggested to screen out the blueberries in much smaller diameters when bulk of blueberries were dried together in order to get uniform drying rate of whole products.

### 3.3 Effect of NaOH Pretreatment on the Drying Characteristics of Fresh Blueberries

NaOH pretreatment resulted in slightly increase of drying rate and much less broken blueberries at temperatures higher than 80° C. For untreated blueberries, nearly all 16 mm blueberries broke at 80° C. after 7 min and 85° C. after 5 min. However, less than 20% blueberries broke at 75° C. after 7 min and 70° C. after 20 min. No blueberry broke at 60° C. after 150 minutes. For 12 mm blueberries, no one broke during the whole drying period even at 80° C. For bulk blueberries dried together, pretreatment with NaOH greatly reduced the number of broken berries and slightly increased the drying rate of blueberries at temperatures higher than 80° C. The percentage of broken blueberries was reduced from more than 78% to less than 25% at 90° C. and from 22% to less than 6% at 80° C. after NaOH pretreatment. For treated and untreated blueberries, there is no blueberries broken during the whole drying course when drying was carried out firstly at 70° C. for 50 min and then at 90° C. for 40 min.

NaOH treatment resulted in slightly higher drying rate of blueberries at 80 and 90° C., which was more significant for smaller blueberries than for bigger blueberries. NaOH treatment showed no influence on the drying rate of blueberries when combination drying temperatures were used. At 70, 80, and 90° C., the weight loss of blueberries after 50 min was 52.1%, 68.1%, and 80.2% respectively, for 12 mm blueberries and 53.8%, 65.2% and 69.6%, respectively, for 16 mm blueberries. For getting rid of 50% weight of fresh blueberries at 70, 80, and 90° C., time needed was 50, 30, and 22 min, respectively, for 12 mm blueberries and 46, 34, and 27 min, respectively, for 16 mm blueberries.

Based on the above results, NaOH treatment is recommended to speed up the drying rate of blueberries. If blueberries were not treated with NaOH before drying, temperature should be controlled at lower than 75° C. 70° C. is recommended as the proper temperature for drying blueberries at stable temperature.

### 3.4 Drying at Variational Temperatures

Blueberries with diameters of 13-16 mm were treated in a bulk with 93° C. 0.1% NaOH for 5 seconds before being dried by drying strategies shown in Table 7. It shows increasing temperature at later drying stage could increase the weight loss of blueberries. 80% and 73.3% weight were removed from blueberries within 75 min and 90 min, separately, by increasing the drying temperature from 75° C. to 85° C. after 30 min. Referring to the taste of dried products, method 2 is recommended for drying of fresh blueberries to shelf-stable moisture content when high drying rate was required.

TABLE 7
Drying fresh blueberries with IR at different temperatures

| | | | |
|---|---|---|---|
| Temperature | | Total time | Weight loss |
| (° C.) | Time (min) | (min) | (%) |

Method 1

| | | | | |
|---|---|---|---|---|
| Step1 | 75 | 50 | | |
| Step2 | 85 | 50 | 100 | 77.8 |

Method 2

| | | | | |
|---|---|---|---|---|
| Step1 | 75 | 30 | | |
| Step2 | 85 | 45 | 75 | 73.3 |

Method 3

| | | | | |
|---|---|---|---|---|
| Step1 | 75 | 30 | | |
| Step2 | 85 | 60 | 90 | 80.0 |

Method 4

| | | | | |
|---|---|---|---|---|
| Step1 | 75 | 30 | | |
| Step2 | 85 | 60 | 90 | 58.4 |

Method 5

| | | | | |
|---|---|---|---|---|
| Step1 | 75 | 5 | | |
| Step2 | 70 | 70 | 75 | 52 |

### 4. Application of IR as Pre-Treatment for Infusion of Blueberries

### 4.1 IR Heating Blueberries Before Infusion

Heating was assumed to form vacuum condition in cells of blueberries by vaporizing water in plant cells and cooling down quickly. In this way, sugar solution might be drawn into plant cells. Blueberries were infused in 40 Brix sucrose solutions at 50° C. immediately after IR heating. The effect of IR heating on the Brix of blueberries after infusion for 4 h was compared to that of other methods listed in Table 8. Heating with IR at 80° C. for 5 min showed helpful to the increase of sugar infusion rate. Such positive effect was enlarged by dipping blueberries in 93° C. for 5 seconds followed by infusing blueberries in 0.5% CaCl₂ solution for 1 hour at room temperature before sugar infusion.

TABLE 8
Soluble solid in blueberries after infusion

| | Brix of blueberries |
|---|---|
| Treatment | after infusion |
| Infusion (control 1) | 13.1 ± 0.2 |
| IR heating + infusion | 14.2 ± 0.1 |
| 0.1% NaOH + 0.5% CaCl₂ + infusion | 13.6 ± 0.4 |
| (control 2) | |
| 0.1% NaOH + 0.5% CaCl₂ + IR heating | 15.3 ± 0.3 |
| infusion | |

Note:
Treatment of 0.1% NaOH means dipping fresh blueberries in 93° C. 0.1% NaOH water solution for 5 seconds; treatment of 0.5% CaCl₂ means infusion of blueberries in 0.5% CaCl₂ for 1 hour at room temperature after NaOH treatment.

### 4.2 Using IR in Partially Drying Blueberries Before Infusion

Bulk of blueberries with diameter of 13-16 mm were dried before being infused in 60 Brix syrup at 40° C. for 12 h. After that, the weight loss and soluble solid of blueberries were measured. The highest soluble solid content of blueberries (32.6 Brix) occurred when 58.4% weight of blueberries were removed before infusion. The highest increase of soluble solid in blueberries (6.7 Brix) after infusion appeared when blueberries were dried with IR at 80° C. for 15 minutes before infusion, corresponding to weight loss of 19.1%. The results are summarized in Table 9.

TABLE 9
Properties of infused blueberries after being partially dried with IR

| | | | Soluble solid | Soluble solid | |
|---|---|---|---|---|---|
| | | Weight loss after | before infusion | after infusion | |
| Drying method | | IR drying (%) | (A) (Brix) | (B) (Brix) | B − A (Brix) |
| 75° C. 4 min | | 5.0 | 16.7 | 16.7 | 0.0 |
| 75° C. 15 min | | 18.3 | 18.1 | 20.2 | 2.1 |
| 75° C. 30 min | | 29.9 | 18.5 | 20.9 | 2.4 |
| Step1: 75 ° C. | Step2: 85° C. | 39.2 | 25.3 | 26.6 | 1.3 |
| 30 min | 15 min | | | | |
| Step1: 75° C. | Step2: 85° C. | 58.4 | 29.9 | 32.6 | 2.7 |
| 30 min | 30 min | | | | |

| | | | | |
|---|---|---|---|---|
| 80° C. 6 min | 9.7 | 16.8 | 19.5 | 2.7 |
| 80° C. 15 min | 19.1 | 17.3 | 24.0 | 6.7 |
| 70° C. 15 min | 7.9 | 16.6 | 17.6 | 1.0 |
| 70° C. 30 min | 18.8 | 16.8 | 19.5 | 2.7 |

At the same infusion condition, the soluble solid in infused blueberries was only 15.5 Brix when fresh blueberries were infused directly without subjecting to partially drying. Therefore, partially drying with IR before infusion seems helpful to dehydration rate of fresh blueberries and increasing the sugar content in infused blueberries.

4.3 Combination of Partially Drying with IR and Freezing Before Infusion

IR was used before freezing and infusion to save energy used for freezing processing and improving infusion rate. In order to investigate suitable the weight loss of blueberries for sugar infusion, infusion rate of blueberries with different weight loss was tested. The IR drying temperature was 70° C. The infusion condition was 60 Brix sucrose solution and 50° C. Infusion rate of blueberries were also tested on the samples treated with freezing alone and freezing plus IR drying. The methods were listed as following.

#1 fresh
#2 fresh+frozen
#3 IR drying for 10% weight loss at 70° C.
#4 50% weight loss
#5 70% weight loss
#6 10% weight loss+frozen
#7 50% weight loss+frozen
#8 70% weight loss+frozen

Compared with the untreated fresh blueberries, all pretreatment methods showed increase of solid gain in blueberries during the infusion course. Solid gain in infusion stage was lower for blueberries with higher weight loss after IR drying. This is independent of the combination of freezing with IR drying. Freezing alone yielded the highest solid gain. The solid gain was reduced slightly when IR drying was combined with freezing.

The yield of dried products with moisture content (w.b.) of 10% was enhanced by all pretreatment methods, except of the method #8, that is drying fresh blueberries to 70% weight loss before freezing followed by infusion. Freezing yielded the most products (0.21 g/g). IR drying to 50% and 70% weight loss combined with freezing took the second (0.19 g/g). IR drying to 10%-70% weight loss alone took the third place (0.17-0.18 g/g). Combination of IR drying and freezing gave similar yield of dried blueberries (0.15 g/g).

Therefore, it can be concluded that IR heating or IR drying before infusion could improve the infusion rate of sugar into blueberries.

Conclusions—Based on the above results, it can be concluded that:

(1) The rate of solid gain and yield of infused blueberries increased with the concentration of infusion media and infusion temperature. Out the view of solid gain and yield of end products, the optimal media concentration and temperature was 70 Brix and 50° C., respectively. High concentration of solution was necessary get high infusion rate and high yield of products. Out the view of product quality and consequent increasing solution concentration processing, 30° C. and 50° C. were recommended when Brix of infusion solution was lower than 50 Brix and higher than 60 Brix, respectively.

(2) Keeping the concentration of infusion solution at a relative stable high level could greatly increase the rate of solid gain in blueberries. Infusion in dynamic infusion system could increase the solid gain rate of blueberries by two times than did in static infusion system. Smaller infusion media showed higher and faster solid gain of blueberries.

(3) Drying temperature, solid content in blueberries, and type of infusion media showed great influence on the drying rate of infused blueberries. The drying rate of infused blueberries increased greatly when temperature increased from 60 to 80° C., but very slightly when temperature increased from 80 to 90° C. Blueberries having high solid content showed low drying rate at first drying stage and reversed trend showed at later drying stage. At same solid content, blueberries infused with fructose showed lower drying rate but higher rate of water activity reduction than did samples infused with sucrose.

(4) For IR drying of fresh blueberries, higher temperature was preferable for increasing drying rate in the range from 60 to 80° C. Slightly increase of drying rate showed when drying temperature increased from 80 to 90° C. Pretreatment with 0.1% NaOH solution for 5 sec could slightly increase the drying rate and significantly reduce the break of blueberries at temperatures higher than 80° C. Uniform drying rate could be obtained by removing blueberries with too small size when bulk of blueberries was dried together.

(5) IR drying could greatly save the drying time without causing any end product quality loss of color. The texture quality, especially chewiness and springiness of blueberries was increased after IR drying. These were true for both fresh blueberries and sugar-infused blueberries.

(6) IR heating and partially drying of fresh blueberries was helpful to the increase of solid gain in blueberries during the sugar infusion period.

### Example 3

### Processing and Infusion Methods for Blueberries

In order to find out the efficient way to infuse blueberry, frozen blueberries provided by the company, sugar and high fructose syrup were used for the tests. The ratio of blueberry to infusion solution was 1:1 in weight unless it was specially pointed out. The soluble solids content in blueberry was measured every 1 hour during the infusion period. Before blending, the blueberry was rinsed with water after taken out from the infusion solution. Content of soluble solids in blueberry was mainly considered in the tests, which is measured with the refractometer and expressed as Brix. Infusion rate, time needed for soluble solid going up to 30 Brix, 40 Brix, 50 Brix, and 60 Brix, were compared for different treatments.

### 1. Preliminary Infusion Tests

Thawing blueberry or frozen blueberry was infused in 57 brix sugar solution at 48-50° C. Thawing blueberries show higher infusion rate than frozen ones, but not significantly. Although blueberries thawed at 4° C. for 2 hours shows a little higher infusion rate than those thawed at 25° C. for 1 hour, the difference is not significant. However, less juice was lost and better color was kept at lower thawing temperature. Therefore, thawing the frozen blueberry at 4° C. before infusion should be better for higher product quality.

### 2. Effects of Blueberry Skin on the Infusion Rate

The skin of blueberry was removed by hand before thawing. Peeled blueberry and unpeeled blueberry were infused in 60 Brix at 48° C. Peeled blueberry shows a much higher infusion rate and end Brix than that of unpeeled blueberry.

It only needs about 5 hours for peeled blueberry to go up to 30 Brix, but 25 hours for unpeeled blueberry. It needs only 8 hours for peeled blueberry to go up to the equilibrium concentration, about 37-38 Brix, however more than 25 hours for unpeeled blueberry it takes to go up to the highest value of 30 Brix.

The soluble solids in peeled blueberry increased to the same level as that of the infusion sugar solution. However, the soluble solids in unpeeled blueberry could not go up to a same level as that in sugar solution. Therefore, the skin of blueberry does not only inhibit infusion procedure, but also decrease the equilibrium concentration of soluble solids in infused blueberry.

### 3. Effects of Temperature and Brix of Solution on the Infusion Rate

Peeled blueberry or unpeeled blueberry was infused in different Brix solution at 48° C. to investigate the effect of sugar concentration, and in 60 Brix at different temperature to investigate the effect of temperature.

For both peeled blueberry and unpeeled blueberry, higher sugar content solution yields higher equilibrium or stable Brix in blueberry, and also it shortens the time needed for blueberry reaching 30 Brix, but prolongs the infusion time (table 12 & table 13). Soluble solids in blueberry could not reach higher than 30 Brix in sugar solution lower than 40 Brix. 60 Brix and 77 Brix sugar solution gave much higher Brix in peeled blueberry (40 Brix and 47.4 Brix respectively) than unpeeled blueberry (29.8 Brix and 34.4 Brix respectively), and less time needed for going up to 30 Brix.

Higher temperature benefits the infusion rate of unpeeled blueberries greatly but not significantly for peeled blueberries. (table 12 & table 13). Table 14 & Table 15 show a summary of the end brix of the infused blueberry and the time needed to go up to 30, 40, 50 brix as highlighted.

TABLE 12
Infusion of unpeeled blueberry

| | 60 Brix | | | | 50° C. | | | |
|---|---|---|---|---|---|---|---|---|
| Time (h) | 25° C. | 40° C. | 60° C. | 80° C. | 20 Brix | 40 Brix | 60 Brix | 77 Brix |
| Brix at the sixth hour | 23.3 | 26.3 | 28.2 | 32.2 | 12.7 | 21.0 | 20.0 | 32.5 |
| Stable concentration (Brix) | 33.5 | 33.2 | 38.1 | 37.8 | 13.6 | 24.2 | 29.8 | 34.4 |
| Time needed to reach 30 Brix (h) | 20 | 20 | 7 | 5.5 | | | 8 | 5 |

TABLE 13
Infusion of peeled blueberry

| | 60 Brix | | | | 50° C. | | | |
|---|---|---|---|---|---|---|---|---|
| Time (h) | 25° C. | 40° C. | 60° C. | 80° C. | 20 Brix | 40 Brix | 60 Brix | 77 Brix |
| Equilibrium time(h) | >8 | 5.5 | 7.5 | 5.5 | 2 | 3 | 7 | 14 |
| Equilibrium concentration (Brix) | 39.1 | 37.0 | 42.2 | 38.3 | 14.1 | 24.0 | 40.0 | 47.4 |
| Time needed to reach 30 Brix (h) | 2.5 | 3.5 | 2.5 | 4 | | | 3.5 | 2 |

TABLE 14
Different brix concentrations tested at a water bath
temperature of 50° C.

| | |
|---|---|
| Peeled | Unpeeled |
| blueberry | blueberry |

Different brix at 50° C.

| Time (hrs) | 20 | 40 | 60 | 77 | 20 | 40 | 60 | 77 |
|---|---|---|---|---|---|---|---|---|
| 3 | 14 | 24 | 27 | 34 | 10 | 17 | 17 | 18 |
| 4 | 15 | 23 | 34 | 38 | 12 | 20 | 21 | 24 |
| 5 | 15 | 23 | 36 | 41 | 13 | 20 | 23 | 30 |
| 6 | 15 | 23 | 37 | 41 | 12 | 21 | 24 | 32 |
| 10 | | | | | | | 30 | |
| 22 | | | 41 | 49 | | | | |

TABLE 15
Different water bath temperatures tested at an intial
60 brix sugar solution

| | |
|---|---|
| Peeled | Unpeeled |
| blueberry | blueberry |

Different temperature at 60 brix

| Time (hrs) | 25 | 40 | 60 | 80 | 25 | 40 | 60 | 80 |
|---|---|---|---|---|---|---|---|---|
| 3 | 33 | 30 | 32 | 26 | 16 | 16 | 22 | 21 |
| 4 | 31 | 32 | 38 | 34 | 16 | 20 | 22 | 25 |
| 5 | 32 | 36 | 39 | 36 | 22 | 24 | 29 | 30 |
| 6 | 35 | 37 | 40 | 38 | 23 | 26 | 28 | 33 |
| 10 | | | | | | | 31 | |
| 22 | | | | | 33 | 33 | | |

From the above results, we can see higher temperature and higher Brix would benefit the infusion rate. For peeled blueberry, using higher Brix solution (75 Brix) at lower temperature (48° C.) provides similar infusion rate as that at higher temperature (60° C.) with lower Brix solution (60 Brix). For unpeeled blueberry, 60 Brix sugar solution provides higher infusion rate at 80° C. as 77 Brix solution at 48° C.

### 4. Effect of Ratio of Blueberry to Infusion Solution on the Infusion Rate

Infusing blueberry in 60 Brix sugar solution at 60° C. shows that there is no significant effect of the solution ratio to blueberry on the infusion rate and Brix in blueberry. Considering from the economical aspects, 1:1 ratio in weight is the most favorable value.

### 5. Methods for Removing the Waxy Cuticle on the Surface of Blueberry

Some methods were tried to remove the waxy cuticle from the surface of blueberry. The methods include (1) dipping blueberry in NaOH at 93° C. for 5 sec; (2) dipping blueberry in 2% glycerol for 3 minutes; (3) dipping blueberry in boiling water for 1 minute. All of the above solutions, including boiling water were made with 10 Brix sugar solution in order to minimize the loss of soluble solids from blueberry. The treated blueberries were washed with water to room temperature quickly. Then, the washed blueberries were infused in 60 Brix at 60° C.

Table 16 shows infusion of treated blueberry is much faster than untreated ones; some of the methods gave fast infusion nearly the same as peeled blueberry. With exception of dipping blueberry in 2% glycerol at 25° C., Brix of blueberry in other treatment all went up to higher than 30 Brix within 3 hours. This is nearly the same speed as peeled blueberry, much faster than control (6 hours).

TABLE 16
Effect of waxy cuticle removing methods on infusion rate

| | | 0.5% | glycerol- | glycerol- | Boiling | | |
|---|---|---|---|---|---|---|---|
| Time (h) | 0.1% NaOH | NaOH | 25° C. | 80° C. | water | unpeeled | peeled |
| 3 | 30.2 ± 2.3 | 32.0 ± 1.3 | 25.4 ± 0.5 | 32.0 ± 2.2 | 35.0 ± 1.4 | 18.0 ± 0.3 | 32.8 ± 1.1 |
| 4 | 29.7 ± 0.3 | 32.8 ± 0.4 | 31.3 ± 1.9 | 29.6 ± 1.3 | 32.4 ± 1.3 | 20.2 ± 2.4 | 38.6 ± 0.9 |
| 5 | 36.1 ± 2.7 | 33.3 ± 4.0 | 27.7 ± 0.9 | 36.2 ± 0.6 | 37.6 ± 0.4 | 25.0 ± 1.5 | 39.2 ± 1.0 |
| 6 | 34.5 ± 0.4 | 36.7 ± 0.3 | 32.2 ± 1.6 | 37.9 ± 1.4 | 37.7 ± 0.4 | 31.8 ± 1.7 | 40.8 ± 0.3 |
| 7 | 37.9 ± 0.9 | 37.3 ± 2.2 | 38.1 ± 0.8 | 37.7 ± 1.3 | 38.5 ± 0.6 | 31.1 ± 1.1 | 42.2 ± 0.1 |
| 21 | 45.5 ± 0.3 | 44.7 ± 0.7 | 41.1 ± 1.9 | 43.70.2 | 44.8 ± 1.3 | 36.6 ± 1.8 | 44.9 ± 0.1 |

### 6. Orthogonal Experiments

In order to find out the better combination of different treatment for increasing the infusion rate, orthogonal experiment design was used. Temperature, Brix of sugar solution, and cuticle removing methods are considered in the experimental design. The results were shown in table 17.

TABLE 17
Result of orthogonal experiments

| Run number | Temperature | Brix | Peeling method | Error | Brix at 3 h | Brix at 5 h | Brix at 6 h |
|---|---|---|---|---|---|---|---|
| 1 | 1 (40) | 1 (50) | 1 (glycerol) | 1 | 19.6 | 23.6 | 28.1 |
| 2 | 1 | 2 (60) | 2 (0.1% NaOH) | 2 | 26.4 | 30.3 | 31.3 |
| 3 | 1 | 3 (70) | 3 (Boiling water) | 3 | 24.8 | 33.9 | 35.1 |
| 4 | 2 (60) | 1 | 2 | 3 | 20.2 | 28.9 | 30.0 |
| 5 | 2 | 2 | 3 | 1 | 23.9 | 30.4 | 30.5 |
| 6 | 2 | 3 | 1 | 2 | 23.9 | 31.8 | 31.6 |
| 7 | 3 (80) | 1 | 3 | 2 | 22.7 | 35.5 | 35.3 |
| 8 | 3 | 2 | 1 | 3 | 26.8 | 42.2 | 41.5 |
| 9 | 3 | 3 | 2 | 1 | 37.5 | 41.2 | 44.6 |

| R | Temperature | Brix | Peeling method |
|---|---|---|---|
| 3 h | 6.32 | 7.90 | 4.58 |
| 5 h | 10.31 | 6.31 | 0.95 |
| 6 h | 9.77 | 5.92 | 1.69 |

| | Temperature | | | Brix of sugar solution | | | Pretreating method | | |
|---|---|---|---|---|---|---|---|---|---|
| | 3 h | 5 h | 6 h | 3 h | 5 h | 6 h | 3 h | 5 h | 6 h |
| K1 | 70.78 | 87.81 | 94.38 | 62.46 | 87.91 | 93.38 | 70.33 | 97.51 | 101.08 |
| K2 | 67.98 | 91.06 | 92.03 | 77.1 | 102.88 | 103.21 | 84.08 | 100.36 | 105.86 |
| K3 | 86.95 | 118.75 | 121.33 | 86.15 | 106.83 | 111.15 | 71.3 | 99.75 | 100.8 |

Table 17 shows the effect of Brix of sugar solution is the greatest within the first 3 hours. The effect of temperature is greatest after 3 hours. The best combination for batch infusion is pretreating the blueberry with 0.1 NaOH at 93° C. for 3 sec, then infusing the treated blueberry in 70 Brix at 80° C. The soluble solids of blueberry can go up to 37.5 Brix after 3 hours and 44.6 Brix after 6 hours, which is even faster than peeled blueberry in 60 Brix at 60° C.

### 7. Infusing Blueberry in Constant Sugar Content Solution

Dipping the blueberry in boiling 10 Brix sugar solution for 1 minute before infusing them in sugar solution at 60° C. The Brix of sugar solution was kept constant at a certain level by adding sugar into the infusion solution.

TABLE 18
Infusion of blueberry in constant Brix sugar solution

| Time (h) | 30 Brix | 40 Brix | 50 Brix | 60 Brix | 70 Brix | 77 Brix |
|---|---|---|---|---|---|---|
| 0 | 9.6 ± 0.5 | 13.7 ± 0.7 | 10.4 ± 0.8 | 9.2 ± 0.8 | 12.4 ± 0.9 | 9.3 ± 1.9 |
| 1 | 11.8 ± 0.6 | 14.6 ± 0.4 | 18.7 ± 0.3 | 15.5 ± 0.0 | 19.0 ± 1.1 | 21.5 ± 3.0 |
| 2 | 16.3 ± 1.8 | 19.1 ± 2.6 | 25.4 ± 1.4 | 31.8 ± 2.8 | 28.6 ± 4.6 | 28.2 ± 0.9 |
| 3 | 18.8 ± 0.0 | 24.4 ± 1.9 | 30.2 ± 0.2 | 31.4 ± 1.1 | 30.6 ± 1.7 | 54.7 ± 0.4 |
| 4 | 23.2 ± 1.2 | 30.2 ± 1.1 | 34.9 ± 1.3 | 35.7 ± 0.8 | 41.9 ± 2.1 | 59.2 ± 0.4 |
| 5 | 25.7 ± 0.7 | 31.5 ± 2.7 | 38.4 ± 2.3 | 47.1 ± 5.2 | 51.9 ± 1.1 | 63.3 ± 5.5 |
| 6 | 25.5 ± 0.6 | 34.1 ± 0.4 | 37.8 ± 1.5 | 44.2 ± 0.6 | 54.1 ± 2.3 | 60.5 ± 2.6 |

Table 18 shows keeping Brix of sugar solution constant benefits the infusion rate very well. With the increase of Brix, the time needed for soluble solids in blueberry going up to 30 Brix becomes shorter. It is only 2 hours when the Brix of sugar solution is kept constant higher than 60 Brix. Keeping Brix of sugar solution constant could also increase the maximum soluble solids in infused blueberry. For example, in 60 Brix sugar solution, the soluble solids in blueberry could go up to 47.1 Brix in constant Brix sugar solution after 5 hours, but only 31 Brix after 10 hours if the Brix of sugar solution was not controlled constantly. Even for peeled blueberry, the soluble solids in blueberry only went up to 40 Brix after 6 hours if the Brix was not kept constant (table 15). However, it should be emphasized that it is difficult to increase the soluble solids in blueberry to 30 Brix, even keeping the Brix of sugar solution constantly at 30 Brix. Therefore, keeping the Brix of sugar solution constant is a very efficient way to increase the infusion rate and the soluble solids in blueberry.

### 8. Increasing the Brix of Sugar Solution by Steps During the Infusion Period

Dipping the blueberry in boiling water for 1 minute, then infusing them in sugar solution at 40° C. or 80° C. The sugar was increased 10 Brix every 1 hour from 50 Brix to 70 Brix, and kept at 70 Brix until the end of infusion. In this way, soluble solids in the blueberry could increase to higher than 30 Brix just within 2 hours and go up to nearly 60 Brix within 8 hours at 80° C. Even at 40° C., the soluble solids of blueberry could go up to higher than 30 Brix within 5 hours and nearly to 50 Brix 8 hours later. The much better one is the end Brix of blueberry is much higher than that infused in sugar solution without increasing the Brix. (table.19). Compared with sugar solution, infusion with syrup has a higher infusion rate at first infusion stage than sugar solution.

TABLE 19
Infusion blueberry in sugar solution with Brix increased by steps

| | |
|---|---|
| 80° C. | 40° C. |

| Time(h) | sugar | Time(h) | sugar | syrup |
|---|---|---|---|---|
| 0 | 11.2 ± 1.3 | 0 | 10.2 ± 1.2 | 8.7 ± 0.2 |
| 1 | 22.3 ± 0.5 | 1 | 20.1 ± 0.6 | 18.8 ± 1.7 |
| 2 | 34.9 ± 0.1 | 2 | 21.6 ± 0.8 | 24.1 ± 1.0 |
| 3 | 50.1 ± 0.2 | 3 | 26.3 ± 0.9 | 34.2 ± 0.3 |
| 4 | 51.3 ± 0.1 | 4 | 27.9 ± 1.3 | 35.4 ± 0.9 |
| 5 | 53.3 ± 0.1 | 5 | 31.4 ± 1.2 | 42.3 ± 0.5 |
| 8 | 59.9 ± 1.4 | 6 | 40.6 ± 1.1 | 43.4 ± 0.2 |
| | | 7 | 43.1 ± 1.2 | 45.0 ± 0.8 |

### 9. Fastening the Infusion by Increasing Temperature by Steps

Blueberries were dipped in 0.1% NaOH at 93° C. for 3 seconds. Then, infusing the treated blueberry in syrup, and increasing the temperature 10° C. every 1 hour, from 50° C. to 80° C. Three methods were used here: (1) the Brix was kept at 70 during the whole infusion period, (2) increasing the soluble solids in syrup by 10 Brix every 1 hour from 50 Brix to 70 Brix, and kept at 70 Brix after that, (3) infusing the blueberry in syrup with initial soluble solids of 70 Brix and not controlling it during the whole infusion period. Table 20 shows method 2 gives the highest Brix after 6 hours. Method 3 gives the shortest time for soluble solids in blueberry going up to 30 Brix (2 hours), but the lowest Brix after 6 hours. Therefore, increasing the Brix of syrup by steps has advantage on higher end Brix and saving syrup.

TABLE 20
Infusion of blueberry in syrup with increasing temperature

| time | method1 | method2 | method3 |
|---|---|---|---|
| 0 | 9.3 ± 0.1 | 10.2 ± 0.8 | 9.6 ± 0.3 |
| 1 | 13.4 ± 0.9 | 15.1 ± 0.3 | 13.1 ± 0.3 |
| 2 | 25.4 ± 5.4 | 25.0 ± 4.3 | 30.5 ± 2.8 |
| 3 | 29.6 ± 0.0 | 29.9 ± 0.2 | 37.9 ± 5.1 |
| 4 | 45.9 ± 5.6 | 41.3 ± 9.5 | 40.9 ± 1.4 |
| 5 | 50.9 ± 0.1 | 57.6 ± 0.2 | 43.4 ± 0.1 |
| 6 | 54.0 ± 2.6 | 60.3 ± 0.2 | 44.4 ± 1.5 |

Conclusion: The skin of blueberry inhibits the sugar infusion greatly. Peeled blueberry has much higher infusion rate than unpeeled ones. Pretreating unpeeled blueberry with boiling water or 0.1% NaOH could increase the infusion rate of blueberry greatly, even up to that level similar to peeled blueberry. Higher temperature and higher sugar concentration of infusion solution benefits the infusion greatly in fastening the infusion rate and increasing the end Brix in blueberry. For batch infusion, the optimal infusion condition is pretreating blueberry in 0.1% NaOH at 93° C. for 3 sec, and then infusing them in 70 Brix solution at 80° C. Keeping the Brix of infusion solution constant, or increasing it by steps, and increasing temperature by steps are all benefit to speed up the infusion procedure. By proper infusion method, soluble solids in infused blueberry could go up to 30 Brix within 2 hours and 60 Brix within 6 hours.

### Example 5

### Infused Raisin

Infrared (IR) drying could be used as predehydration method for infused raisins to remove a portion of the moisture followed by hot air drying. The recommended weight reduction level is 5%-8% by using the IR drying for 3-5 min. The expected overall drying time saving caused by IR predehydration is 15% or more.

Materials and Methods: Golden raisins were infused for 24 h with formula of 4540 g of raisins, 4540 g of 30° Brix grape juice concentrate, 91.6 g of raspberry flavor (2%) and 23.7 g of red color (2%). The wet weight of infused sample was 6356 g. After the sample was drained, the sample weight was 5900 g, which gained 30% of original weight.

The total four drying tests were conducted to achieve final moisture content of dried-infused samples similar to the original moisture content of golden raisins. The first three tests used infrared drying with pilot catalytic IR dryer to remove different amount of moistures followed by using hot air drying at 145° F.

The sample weights were determined at different drying stages. The water activities of the finished samples were also measured using a water activity meter.

Results: The samples of IR #1 and #2 were dried for 3 and 5 min with gas pressure at 1.5″ Hg. For the IR#2 test, the sample tray was taken out for a 30 s from the dryer to cool the sample down to avoid overheating after 3 min drying. The weight reduction levels were 5.0% and 8.5% for the IR #1 and IR #2, respectively. For the IR #3 test, 12.9% weight reduction was achieved with intermittent heating at a low gas pressure for 23 min. Because the emitters were not on during the drying due to the low pressure setting, the total IR drying time was long.

After IR drying additional 0.6% to 1.9% weight reduction occurred during cooling due to the sensible heat removal. The low weight reduction during the IR drying corresponded more weight reduction during cooling. The weigh reduction does not need any additional energy input.

After 5 h hot air drying, the regular sample (control without IR drying) had 25.4% weight reduction compared to 28.6% to 29.4% weight reductions of IR dried samples. The samples with about 30% weight reduction should have similar moisture content of the noninfused golden raisins. After 7 h 17 min hot air drying, all IR dried samples had weigh reductions about 32% compared to 30% of regular sample even though the water activities were similar.

If the 30% weight reduction is desirable, the estimated time saving could be about 1 h or more by removing 5.0% sample weigh during a 3 min period using IR, which means 15% or more time saving than hot air drying.

TABLE 21
Drying result summary

Weight reduction (%)

| | | | | | | Hot air drying | | |
|---|---|---|---|---|---|---|---|---|
| | Drying | | Initial | After IR | Before hot | time | | Water |
| | Methods | | W. | drying | air drying | 5 h | 7 h 17 min | activity |
| Infused | IR + | IR | 1945 | 5.0 | 6.9 | 28.6 | 31.8 | 0.495 |
| golden raisins | Hot Air | #1 | | | | | | |
| | | IR | 2026 | 8.5 | 11.0 | 29.0 | 32.1 | 0.488 |
| | | #2 | | | | | | |
| | | IR | 1960 | 12.9 | 13.5 | 29.4 | 32.2 | 0.511 |
| | | #3 | | | | | | |
| | Hot Air | | 1816.5 | | | 25.4 | 30.2 | 0.485 |
| Golden raisins | | | | | | | | 0.558 |
| Black raisins | | | | | | | | 0.527 |

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A method of infusing a composition into a food product, the method comprising:
a. scarifying the food product by pretreating the food product with a chemical or an enzyme; and
b. incubating the food product with a infusion solution having a Brix of from 50° Brix to 70° Brix at a temperature from 20° C. to 80° C., thereby infusing the composition into the food product.

2. The method of claim 1, wherein the food product is pretreated with a solution comprising sodium hydroxide.

3. The method of claim 1, wherein the food product is pretreated with potassium carbonate.

4. The method of claim 1, wherein the food product is pretreated with pectinase.

5. The method of claim 1, wherein the food product is pretreated by boiling in water for a period of time.

6. The method of claim 1, wherein the food product is pretreated with a a mixture comprising potassium sorbate, calcium lactate, citric acid, and glycerin, wherein the mixture forms a coating on the food product.

7. The method of claim 1, wherein the food product is pretreated with surfactant.

8. The method of claim 1, wherein the Brix of the infusion solution is maintained from 50° Brix to 70° Brix during the incubating step.

9. The method of claim 1, wherein the infusion solution has a Brix of from 68° Brix to 70° Brix.

10. The method of claim 1, wherein the Brix of the infusion solution is maintained constant during the incubating step.

11. The method of claim 1, wherein the incubating step is carried out at a temperature from 50° C. to 80° C.

12. The method of claim 1, wherein the infusion solution comprises a sugar.

13. The method of claim 12, wherein the sugar is selected from the group consisting of fructose, glucose, dextrose, polydextrose, sucrose, maltodextrin, and corn syrup.

14. The method of claim 12, wherein the infusion solution comprises grape juice concentrate.

15. The method of claim 1, wherein the infusion solution comprises fruit concentrates pretreated with an invertase.

16. The method of claim 1, wherein the infusion solution comprises one or more additional infusion agents.

17. The method of claim 16, wherein the additional infusion agent is glycerol.

18. The method of claim 16, wherein the additional infusion agent is inulin.

19. The method of claim 1, wherein the food product is dehydrated prior to the incubating step, wherein the dehydration results in up to about 10% water loss in the food product.

20. The method of claim 19, wherein the food product is dehydrated using infrared heat.

21. The method of claim 19, wherein the food product is pretreated with sodium hydroxide.

22. The method of claim 1, further comprising:
c. coating the infused food product with a coating material.

23. The method of claim 22, wherein the coating material is permeable.

24. The method of claim 22, wherein the coating material is impermeable.

25. The method of claim 1, wherein the food product is a fruit.

26. The method of claim 1, wherein the food product is a vegetable.

27. A method of infusing invert sugar into blueberries, the method comprising:
a. scarifying the blueberries by pretreating the blueberries with a solution comprising sodium hydroxide;
b. incubating the blueberries with the infusion solution having a Brix of from 50° Brix to 70° Brix at a temperature from 50° C. to 80° C., thereby infusing the invert sugar into the blueberries; and
c. coating the infused blueberries with a coating material;
wherein the blueberries are dehydrated prior to the incubating step, wherein the dehydration results in up to about 10% water loss in the blueberries, and wherein the brix of the infusion solution is maintained constant during the incubating step.
